(19) United States
(12) Patent Application Publication
(10) Pub. No.: US 2017/0204659 A1
(43) Pub. Date: Jul. 20, 2017

(54) ROLLER SHADE LATCHING APPARATUS

(71) Applicant: Crestron Electronics, Inc., Rockleigh, NJ (US)

(72) Inventors: Robert Marcinik, Wallkill, NY (US); David Paolazzi, North Arlington, NJ (US)

(73) Assignee: Crestron Electronics, Inc., Rockleigh, NJ (US)

(21) Appl. No.: 15/404,845

(22) Filed: Jan. 12, 2017

Related U.S. Application Data
(60) Provisional application No. 62/279,225, filed on Jan. 15, 2016.

(51) Int. Cl. E06B 9/46; E06B 9/58; F16M 13/02; E06B 9/42

(52) U.S. Cl. CPC E06B 9/46; E06B 9/42; E06B 9/58; F16M 13/02; E06B 2009/587

(57) ABSTRACT

A latching apparatus is disclosed. A latching frame has at least one end portion that includes a guiding edge. At least one latching member has a curved part and a guiding edge located at an outer end of the curved part, and is coupled at a pivot to the end portion such that the guiding edge and the curved part of the latching member face the guiding edge of the end portion. The curved part of the latching member and the guiding edge of the end portion form an opening. At least one spring is coupled at one end to the latching member such that the spring exerts a force that drives the curved part of the latching member about the pivot toward the guiding edge of the end portion. The guiding edge of the latching member is configured to guide an external mounting pin toward the opening in response to the mounting pin being pushed against the guiding edge of the latching member whereby the mounting pin initially causes the latching member to pivot away from the end portion until the mounting pin slides past the guiding edge of the latching member and is secured between the curved part of the latching member and the guiding edge of the end portion by the force exerted by the spring.

### CROSS-REFERENCE TO RELATED APPLICATIONS

This application claims the benefit of the filing date of U.S. Provisional Patent Application No. 62/279,225, filed Jan. 15, 2016, the disclosure of which is incorporated herein by reference.

### BACKGROUND OF THE INVENTION

Technical Field

The present embodiments relates generally to roller shade latching, and more particularly to a roller shade latching apparatus that couples to a shade mounting bracket using spring-loaded latching members.

Background Art

Roller shades are typically hung in place over a window using simple hooks. Gravity is the force that holds the roller shade in place. Due to rotational forces, the roller shade can move and cause noise. Further, to remove or unhang the roller shade, the roller shade must be lifted up to disengage the hooks. Lifting a large diameter shade up to disengage the hooks can be difficult due to the lack of space between the shade and ceiling (i.e., head room).

It is therefore desirable to provide a roller shade latching apparatus that more securely holds the roller shade in place and which can more readily engage and disengage the roller shade.

### SUMMARY OF THE INVENTION

It is to be understood that both the general and detailed descriptions that follow are exemplary and explanatory only and are not restrictive.

### DISCLOSURE OF INVENTION

In accordance with an aspect, a latching apparatus, comprises: (a) a latching frame having at least one end portion that includes a guiding edge; (b) at least one latching member having a curved part and a guiding edge located at an outer end of the curved part, and being coupled at a pivot to the end portion such that the guiding edge and the curved part of the latching member face the guiding edge of the end portion, the curved part of the latching member and the guiding edge of the end portion forming an opening; and (c) at least one spring coupled at one end to the latching member such that the spring exerts a force that drives the curved part of the latching member about the pivot toward the guiding edge of the end portion; wherein (d) the guiding edge of the latching member is configured to guide an external mounting pin toward the opening in response to the mounting pin being pushed against the guiding edge of the latching member whereby the mounting pin initially causes the latching member to pivot away from the end portion until the mounting pin slides past the guiding edge of the latching member and is secured between the curved part of the latching member and the guiding edge of the end portion by the force exerted by the spring.

According to another aspect, a latching apparatus, comprises: (a) a latching frame that includes a first end portion located at one end of the latching frame and a second end portion located at another end of the latching frame, each having a respective guiding edge; (b) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening; (c) a first spring coupled at one end to the first latching member and at another end to the first end portion such that the first spring exerts a force that drives the curved part of the first latching member about the first pivot toward the guiding edge of the first end portion, (d) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening; (e) a second spring coupled at one end to the second latching member and at another end to the second end portion such that the second spring exerts a force that drives the curved part of the second latching member about the second pivot toward the guiding edge of the second end portion; wherein (f) the guiding edge of the first latching member is configured to guide a first mounting pin of an external bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the first spring, and (g) the guiding edge of the second latching member is configured to guide a second mounting pin of the external bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the second spring.

According to a further aspect, a latching apparatus, comprises: (a) a latching frame that includes a first end portion located at one end of the latching frame and a second end portion located at another end of the latching frame, each having a respective guiding edge; (b) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening; (c) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening; (d) a spring coupled at one end to the first latching member and at another end to the second latching member such that the spring exerts a force that drives the curved part of the first latching member about the first pivot toward the guiding edge of the first end portion and drives the curved part of the second latching member about the second pivot toward the guiding edge of the second end portion; wherein (e) the guiding edge of the first latching member is configured to guide a first mounting pin of an external bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the spring, and (f) the guiding edge of the second latching member is configured to guide a second mounting pin of the external bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the spring.

According to yet another aspect, a latching system, comprises: (a) a bracket including a first mounting pin and a second mounting pin; and (b) a latching apparatus, comprising: (i) a latching frame that includes a first end portion located at one end of the latching frame and a second end portion located at another end of the latching frame, each having a respective guiding edge, (ii) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening, (iii) a first spring coupled at one end to the first latching member and at another end to the first end portion such that the first spring exerts a force that drives the curved part of the first latching member about the first pivot toward the guiding edge of the first end portion, (iv) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening, (v) a second spring coupled at one end to the second latching member and at another end to the second end portion such that the second spring exerts a force that drives the curved part of the second latching member about the second pivot toward the guiding edge of the second end portion, wherein (vi) the guiding edge of the first latching member is configured to guide the first mounting pin of the bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the first spring, and (vii) the guiding edge of the second latching member is configured to guide the second mounting pin of the bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the second spring.

According to a still further aspect, a latching system, comprises: (a) a bracket including a first mounting pin and a second mounting pin; and (b) a latching apparatus, comprising: (i) a latching frame that includes a first end portion located at one end of the latching frame and a second end portion located at another end of the latching frame, each having a respective guiding edge; (ii) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening; (iii) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening; (iv) a spring coupled at one end to the first latching member and at another end to the second latching member such that the spring exerts a force that drives the curved part of the first latching member about the first pivot toward the guiding edge of the first end portion and drives the curved part of the second latching member about the second pivot toward the guiding edge of the second end portion; wherein (v) the guiding edge of the first latching member is configured to guide the first mounting pin of the bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the spring, and (vi) the guiding edge of the second latching member is configured to guide the second mounting pin of the bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the spring.

### BRIEF DESCRIPTION OF DRAWINGS

The accompanying figures further illustrate the present embodiments.

The components in the drawings are not necessarily drawn to scale, emphasis instead being placed upon clearly illustrating the principles of the present embodiments. In the drawings, like reference numerals designate corresponding parts throughout the several views.

### BRIEF DESCRIPTION OF THE SEVERAL VIEWS OF THE DRAWING

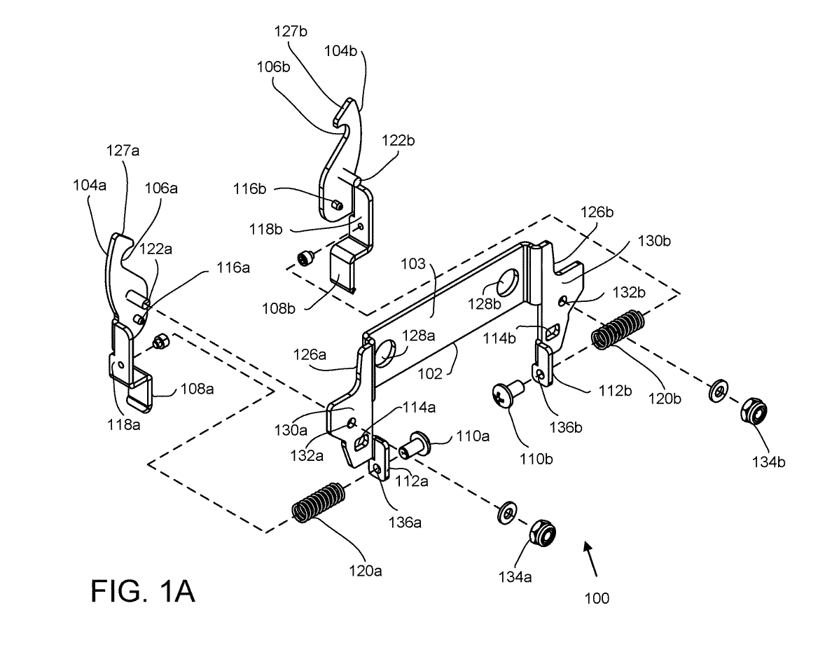

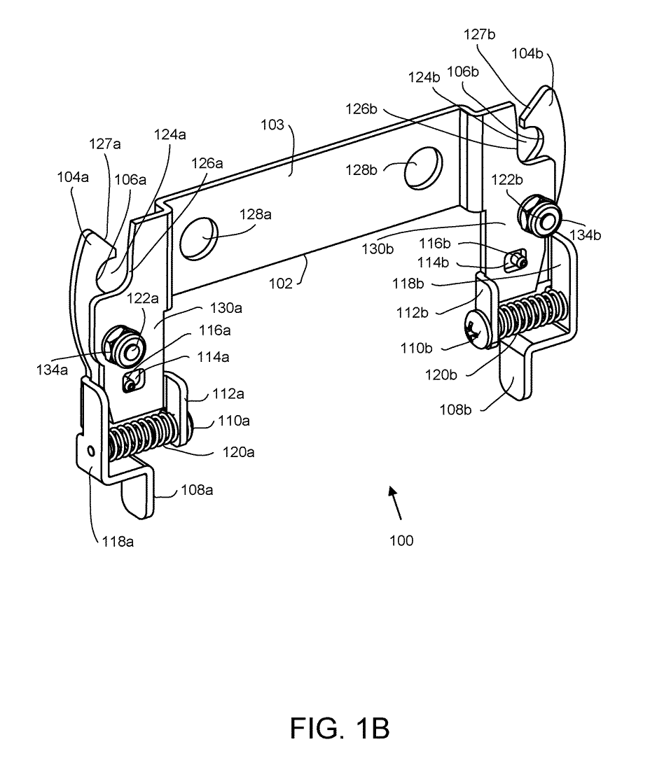

FIG. 1A is an exploded view of and FIG. 1B is an illustrative isometric projection of a shade latching apparatus, according to one embodiment.

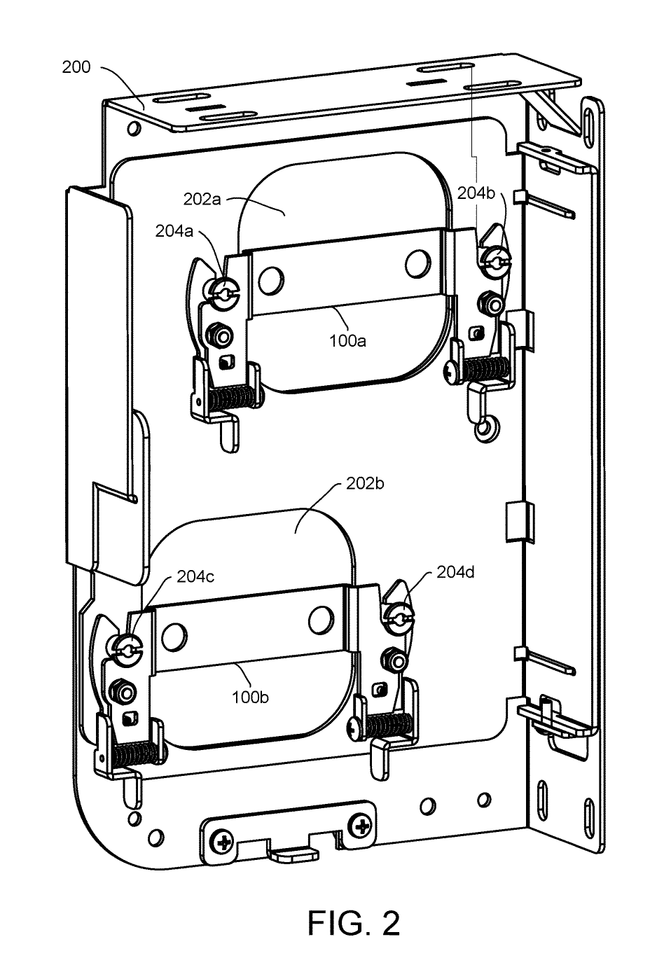

FIG. 2 is an illustrative isometric projection of a dual shade motor bracket with two shade latching apparatuses of FIGS. 1A-1B disposed therein, according to one embodiment.

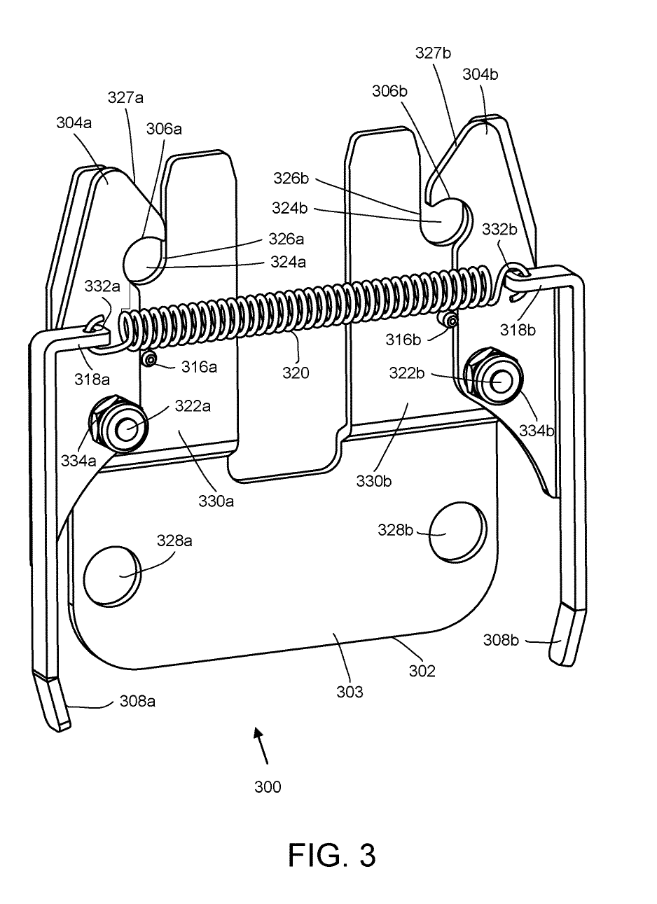

FIG. 3 is an illustrative isometric projection of a shade latching apparatus, according to another embodiment.

### DETAILED DESCRIPTION OF THE INVENTION

Reference will now be made to the exemplary embodiments illustrated in the drawings, and specific language will be used herein to describe the same. It will nevertheless be understood that no limitation of the scope of the embodiments is thereby intended. Alterations and further modifications of the inventive features illustrated herein, and additional applications of the principles of the embodiments as illustrated herein, which would occur to one skilled in the relevant art and having possession of this disclosure, are to be considered within the scope of the embodiments.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### LIST OF REFERENCE NUMBERS FOR THE MAJOR ELEMENTS IN THE DRAWINGS

The following is a list of the major elements in the drawings in numerical order.
100 shade latching apparatus
102 latching frame
103 horizontal portion
104a left latching member
104b right latching member
106a left curved portion
106b right curved portion
108a left latching member actuating portion
108b right latching member actuating portion
110a left spring retention screw
110b right spring retention screw
112a left inside spring retention member
112b right inside spring retention member
114a left pin pocket stop
114b right pin pocket stop
116a left pin
116b right pin
118a left outside spring retention member
118b right outside spring retention member
120a left compression spring
120b right compression spring
122a left threaded pivot
122b right threaded pivot
124a left opening
124b right opening
126a left vertical portion guiding edge
126b right vertical portion guiding edge
127a left latching member guiding edge
127b right latching member guiding edge
128a left through hole
128b right through hole
130a left vertical portion
130b right vertical portion
132a left vertical portion through hole
132b right vertical portion through hole
134a nut
134b nut
136a threaded hole
136b threaded hole
200 dual shade motor bracket
202a first opening
202b second opening
204a first mounting pin
204b second mounting pin
204c third mounting pin
204d fourth mounting pin
300 shade latching apparatus
302 latch frame
303 horizontal portion
304a left latching member
304b right latching member
306a left curved portion
306b right curved portion
308a left latching member actuating portion
308b right latching member actuating portion
316a left pin
316b right pin
318a left spring retention member
318b right spring retention member
320 extension spring
322a left threaded pivot
322b right threaded pivot
324a left opening
324b right opening
326a left vertical portion guiding edge
326b right vertical portion guiding edge
327a left latching member guiding edge
327b right latching member guiding edge
328a left through hole
328b right through hole
330a left vertical portion
330b right vertical portion
332a left latching member through hole
332b right latching member through hole
334a nut
334b nut

### MODE(S) FOR CARRYING OUT THE INVENTION

The embodiment described herein in the context of roller shade latching, but is not limited thereto, except as may be set forth expressly in the appended claims.

Disclosed is a roller shade latching apparatus or mechanism that includes one or more springs to positively hold the shade in place. The disclosed shade latching mechanism allows the shade to be placed (i.e., hung) over a window by simply pushing the shade up or in to engage the shade mounting bracket. The latch provides a crisp “snap” sound that indicates to the installer that the roller tube is in place. The geometry of the latch is such that the weight of the shade helps to provide more holding force. Removing the shade is accomplished by squeezing the latch brackets which allows the shade to disengage from the pins, as described in detail herein below.

Referring to FIGS. 1A-1B, in one embodiment, an illustrative exploded view of a shade latching apparatus/mechanism 100 is shown in FIG. 1A, and an illustrative isometric projection of the shade latching apparatus/mechanism 100 is shown in FIG. 1B. The latching mechanism 100 includes a latching frame 102, which includes a horizontal portion 103, a left vertical portion 130a, and a right vertical portion 130b. The latching mechanism 100 further includes a left compression spring 120a, a right compression spring 120b, a left latching member 104a, and a right latching member 104b. The horizontal portion 103 defines a left through hole 128a and a right through hole 128b. The left and right through holes 128a, 128b are dimensioned and arranged to receive a mounting screw therethrough for coupling the latching mechanism 100 to a shade motor.

The left vertical portion 130a defines a left pin pocket stop 114a and a left through hole 132a. The left pin pocket stop 114a is dimensioned and arranged for receiving a left pin 116a. The left through hole 132a is dimensioned and arranged for receiving a left threaded pivot 122a. The left vertical portion 130a includes a left inside spring retention member 112a that defines a threaded hole 136a dimensioned and arranged for receiving a left spring retention screw 110a. The left vertical portion 130a further includes a left vertical portion guiding edge 126a.

The right vertical portion 130b defines a right pin pocket stop 114b and a right through hole 132b. The right pin pocket stop 114b is dimensioned and arranged for receiving a right pin 116b. The right through hole 132b is dimensioned and arranged for receiving a right threaded pivot 122b. The right vertical portion 130b includes a right inside spring retention member 112b that defines a threaded hole 136b dimensioned and arranged for receiving a right spring retention screw 110b. The right vertical portion 130b further includes a right vertical portion guiding edge 126b.

The left latching member 104a includes a left latching member actuating portion 108a, a left outside spring retention member 118a, a left curved portion 106a, a left latching member guiding edge 127a, and the left pin 116a. The left threaded pivot 122a may be a threaded stud that is affixed to the left latching member 104a. Alternatively, the left threaded pivot 122a may be a screw, and the left latching member 104a defines a threaded hole (not shown) dimensioned and arranged for receiving the screw therethrough.

The right latching member 104b includes a right latching member actuating portion 108b, a right outside spring retention member 118b, a right curved portion 106b, a right latching member guiding edge 127b, and the right pin 116b. The right threaded pivot 122b may be a threaded stud that is affixed to the right latching member 104b. Alternatively, the right threaded pivot 122b may be a screw, and the right latching member 104b defines a threaded hole (not shown) dimensioned and arranged for receiving the screw therethrough.

The left latching member 104a is coupled to the left vertical portion 130a by passing the left threaded pivot 122a through the left through hole 132a in the left vertical portion 130a and then securing the left latching threaded pivot 122a with a nut 134a. The left pin 116a is also disposed in the left pin pocket stop 114a. The left compression spring 120a is disposed between the left outside spring retention member 118a and the left inside spring retention member 112a. The spring retention screw 110a is secured in the threaded hole 136a in the left inside spring retention member 112a and is disposed into the left compression spring 120a.

The right latching member 104b is coupled to the right vertical portion 130b by passing the right threaded pivot 122b through the right through hole 132b in the right vertical portion 130b and then securing the right latching pivot screw 122b with a nut 134b. The right pin 116b is also disposed in the right pin pocket stop 114b. The right compression spring 120b is disposed between the right outside spring retention member 118b and the right inside spring retention member 112b. The spring retention screw 110b is secured in the threaded hole 136b and is disposed into the right compression spring 120b.

When the latching mechanism is assembled, the left curved portion 106a of the left latching member 104a and the guiding edge 127a of the left vertical portion 130a form an opening 124a, and the right curved portion 106b of the right latching member 104b and the guiding edge 127b of the right vertical portion 130b form an opening 124b. The left latching member 104a pivots (left or right) about the left threaded pivot 122a. The left pin pocket stop 114a restricts the range of movement of the left pin 116a and thereby limits the pivoting motion of the left latching member 104a. The right latching member 104b pivots (left or right) about the right threaded pivot 122b. The right pin pocket stop 114b restricts the range of movement of the right pin 116b and thereby limits the pivoting motion of the right latching member 104b.

Referring to FIG. 2, in one embodiment, an illustrative isometric projection of a dual shade motor bracket 200 with two shade latching mechanisms 100 disposed therein is shown. The dual shade motor bracket 200 defines a plurality of mounting through holes dimensioned and arranged to receive mounting screws therethrough for the purpose of securing the dual shade bracket 200 to a wall. The dual shade motor bracket 200 further defines a first opening 202a and a second opening 202b. The dual shade motor bracket 200 includes a first mounting pin 204a and a second mounting pin 204b disposed on opposite sides of the first opening 202a. The dual shade motor bracket 200 further includes a third mounting pin 204c and a fourth mounting pin 204d disposed on opposite sides of the first opening 202b. The mounting pins 204a, 204b, 204c, 204d are dimensioned and arranged to receive a latching shade mechanism 100, as described above.

In one embodiment, in operation, the latching mechanism 100 is mounted to a shade motor via through holes 128a, 128b. The shade motor is inserted into one end of a roller shade roller tube and an idler is inserted into the opposite end of the roller shade roller tube.

The idler includes an idler pin, which is then inserted into a mounted idler bracket. Thereafter, the side of the roller shade tube that includes the shade motor and coupled latching mechanism 100 is pushed toward a mounted roller shade motor bracket that includes a first mounting pin and a second mounting pin, as shown in FIG. 2.

Referring to FIGS. 1A-1B and 2, as the roller shade motor side of the roller shade is pushed into the motor bracket, the first mounting pin 204a contacts the left vertical portion guiding edge 126a (and the left latching member guiding edge 127a), and the second mounting pin 204b contacts the right vertical portion guiding edge 126b (and the right latching member guiding edge 127b). The first mounting pin 204a then pushes the left vertical portion guiding edge 126a and causes the left latching member 104a to pivot left (about the threaded pivot 122a) and compress the left compression spring 120a until the first mounting pin 204a slides into the left opening 124a. Concurrently, the second mounting pin 204b pushes the right vertical portion guiding edge 127b and causes the right latching member 104b to pivot right (about the threaded pivot 122b) and compress the right compression spring 120b until the second mounting pin 204b slides into the right opening 124b. Thereafter, the left spring 120a pushes the left latch member 104a to pivot right and retain the first mounting pin 204a, and the right spring 120b pushes the right latch member 104b to pivot left and retain the second mounting pin 204b. The amount of holding force of the latching mechanism 100 is determined by tension of the springs 120a, 120b and the weight of the roller shade.

To release the latching mechanism (i.e., unlatch the latching mechanism) from the first and second mounting pins 204a, 204b, the left latching member actuating portion 108a and the right latching member actuating portion 108b are simultaneously pushed (e.g., by a technician/installer) toward each other to compresses the left and right springs 120a, 120b, respectively. The spring compression causes the left latching member 104a to pivot left (about the threaded pivot 122a), and the right latching member 104b to pivot right (about the threaded pivot 122b) until both the left curved portion 127a and the right curved portion 127b move enough to allow first mounting member 204a to slide out of the left opening 124a and the second mounting member 204b to slide out of the right opening 124b.

Referring to FIG. 3, in another embodiment, an illustrative isometric projection of a shade latching apparatus/mechanism 300 is shown. Here, a single extension spring is used instead of the right and left springs of the embodiment shown in FIG. 1, and the pivoting motion of the latching members are limited by pins affixed to the frame.

The latching mechanism 300 includes a latching frame 302 which includes a horizontal portion 303, a left vertical portion 330a, and a right vertical portion 330b. The latching mechanism 300 further includes an extension spring 320, a left latching member 304a, and a right latching member 304b. The horizontal portion 303 defines a left through hole 328a and a right through hole 328b. The left and right through holes 328a, 328b are dimensioned and arranged to receive a mounting screw therethrough for coupling the latching mechanism 300 to a shade motor.

A left threaded pivot 322a may be a threaded stud that is affixed to the left vertical portion 330a. Alternatively, the left threaded pivot 322a may be a screw, and the left vertical portion 330a defines a left threaded hole (not shown) that is dimensioned and arranged for receiving the screw. The left vertical portion 330a includes a left pin 316a and a left vertical portion guiding edge 326a.

A right threaded pivot 322b may be a threaded stud that is affixed to the right vertical portion 330b. Alternatively, the right threaded pivot 322b may be a screw, and the right vertical portion 330b defines a right threaded hole (not shown) that is dimensioned and arranged for receiving the screw. The right vertical portion 330b includes a right pin 316a and a right vertical portion guiding edge 326a.

The left latching member 304a includes a left latching member actuating portion 308a, a left outside spring retention member 318a, a left curved portion 306a, and a left latching member guiding edge 327a. The left latching member 304a defines a through hole (not shown) dimensioned and arranged for receiving therethrough the left threaded pivot 322a. The left outside spring retention member 318a defines a through hole 332a dimensioned and arranged for receiving therethrough one end of the extension spring 320.

The right latching member 304b includes a right latching member actuating portion 308b, a right outside spring retention member 318b, a right curved portion 306b, and a right latching member guiding edge 327b. The right latching member 304b defines a through hole (not shown) dimensioned and arranged for receiving therethrough the right threaded pivot 322b. The right outside spring retention member 318b defines a through hole 332b dimensioned and arranged for receiving therethrough the other end of the extension spring 320.

The left latching member 304a is coupled to the left vertical portion 330a by passing the left threaded pivot 322a through a left through hole (not shown) in the latching member 304a and then securing the left threaded pivot 322a with a nut 334a.

The right latching member 304b is coupled to the right vertical portion 330b by passing the right threaded pivot 322b through a through hole (not shown) in the right latching member 304b and then securing the right threaded pivot 322b with a nut 334a.

When the latching mechanism 300 is assembled, the left vertical portion 330a and the left curved portion 306a form an opening 324a, and the right vertical portion 330b and right curved portion 306b form an opening 124b. The left latching member 304a pivots about the left threaded pivot 322a, and the right latching member 304b pivots about the right threaded pivot 322b. The left pin 316a limits the right pivotal motion of the left latching member 304a, and the right pin 316b limits the left pivotal motion of the right latching member 304b. One end of the extension spring 320 is disposed through the through hole 332a, and the other end of the extension spring 320 is disposed through the through hole 332b.

In one embodiment, in operation, the latching mechanism 300 is mounted to a shade motor via through holes 328a, 328b. The shade motor is inserted into one end of a roller shade roller tube and an idler is inserted into the opposite end of the roller shade roller tube. The idler includes an idler pin, which is then inserted into a mounted idler bracket. Thereafter, the side of the roller shade tube that includes the shade motor and coupled latching mechanism 300 is pushed toward a mounted roller shade motor bracket that includes a first mounting pin and a second mounting pin (see FIG. 2).

Similar to that described above with respect to FIGS. 1 and 2, and referring to FIG. 3, as the roller shade motor side of the roller shade is pushed into the motor bracket, a first mounting pin contacts the left vertical portion guiding edge 326a and the left latching member guiding edge 327a, and a second mounting pin contacts the right vertical portion guiding edge 326b and the right latching member guiding edge 327b. The first mounting pin pushes the left latching member 304a to pivot left (about the threaded pivot 322a) and extend the extension spring 320a, and the second mounting pin pushes right latching member 304b to pivot right (about the threaded pivot 322b) and also extend the extension spring 320b until the first mounting pin slides into the left opening 324a and the second mounting pin slides into the right opening 324b.

Thereafter, the extension spring 320 pulls the left latch member 104a to pivot right and latch the first mounting pin, and the extension spring 320 pulls the right latch member 304b to pivot left and latch the second mounting pin. The amount of holding force of the latching mechanism 300 is determined by the spring 320 and the weight of the roller shade.

To release the latching mechanism 300 (i.e., de-latch the latching mechanism) from the first and second mounting pins, the left latching member actuating portion 308a and the right latching member actuating portion 308b are simultaneously pushed (e.g., by a technician/installer) toward each other to simultaneously pivot the left and right latching members 304a, 304b away from each other and extend the extension spring 320 until both the left curved portion 327a and the right curved portion 327b move enough to allow left mounting member to slide out of the left opening 324a and the right mounting member to slide out of the right opening 324b.

In various embodiments, the latching mechanisms 100, 300 are made of aluminum, stainless steel, fiberglass, plastic, or any other suitable material known to those skilled in the art.

In the Décor version, the spring is extended by the latching operation. Once the shade is lifted into place, the spring forces the bracket to close on the pin. The amount of holding force is determined by the spring and the weight of the shade.

### INDUSTRIAL APPLICABILITY

To solve the aforementioned problems, the present embodiments provide a roller shade latching apparatus that couples to a shade mounting bracket using spring-loaded latching members.

### Alternate Embodiments

Alternate embodiments may be devised without departing from the spirit or the scope of the embodiments.

What is claimed is:

1. A latching apparatus, comprising:
(a) a latching frame having at least one end portion that includes a guiding edge;
(b) at least one latching member having a curved part and a guiding edge located at an outer end of the curved part, and being coupled at a pivot to the end portion such that the guiding edge and the curved part of the latching member face the guiding edge of the end portion, the curved part of the latching member and the guiding edge of the end portion forming an opening; and
(c) at least one spring coupled at one end to the latching member such that the spring exerts a force that drives the curved part of the latching member about the pivot toward the guiding edge of the end portion; wherein
(d) the guiding edge of the latching member is configured to guide an external mounting pin toward the opening in response to the mounting pin being pushed against the guiding edge of the latching member whereby the mounting pin initially causes the latching member to pivot away from the end portion until the mounting pin slides past the guiding edge of the latching member and is secured between the curved part of the latching member and the guiding edge of the end portion by the force exerted by the spring.

2. The latching apparatus of claim 1, further comprising at least one actuating portion configured to compress the spring and cause the latching member to pivot away from the latching frame in response to pressure being applied to the actuating portion.

3. The latching apparatus of claim 1, wherein the spring is coupled at another end to the end portion of the latching frame.

4. The latching apparatus of claim 1, wherein the pivot comprises a threaded stud that is affixed at an end to one of the latching member or the end portion, and which extends through an opening formed in another of the latching member or the end portion.

5. The latching apparatus of claim 1, further comprising a pin formed in one of the latching member or the end portion, and an opening formed in another of the latching member or the end portion and that receives the pin, wherein motion of the latching member about the pivot is stopped by the pin contacting a wall of the opening.

6. The latching apparatus of claim 1, further comprising a pin formed in the at least one end portion of the latching frame, wherein motion of the latching member about the pivot is stopped by the latching member contacting the pin.

7. The latching apparatus of claim 1, wherein
(i) the at least one end portion includes
(A) a first end portion located at one end of the latching frame and having a guiding edge, and
(B) a second end portion located at another end of the latching frame and having a guiding edge;
(ii) the at least one latching member includes
(A) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening, and
(B) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening.

8. The latching apparatus of claim 7, wherein
(iii) the at least one spring includes
(A) a first spring coupled at one end to the first latching member and at another end to the first end portion such that the first spring exerts a force that drives the curved part of the first latching member about the first pivot toward the guiding edge of the first end portion, and
(B) a second spring coupled at one end to the second latching member and at another end to the second end portion such that the second spring exerts a force that drives the curved part of the second latching member about the second pivot toward the guiding edge of the second end portion; wherein
(iv) the guiding edge of the first latching member is configured to guide an external first mounting pin toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the first spring, and
(v) the guiding edge of the second latching member is configured to guide an external second mounting pin toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the second spring.

9. The latching apparatus of claim 7, wherein
(iii) the at least one spring is a spring coupled at one end to the first latching member and at another end to the second latching member such that the spring exerts a force that drives the curved part of the first latching member about the first pivot toward the guiding edge of the first end portion and drives the curved part of the second latching member about the second pivot toward the guiding edge of the second end portion; wherein
(iv) the guiding edge of the first latching member is configured to guide an external first mounting pin toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the spring, and
(v) the guiding edge of the second latching member is configured to guide an external second mounting pin toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the spring.

10. A latching apparatus, comprising:
(a) a latching frame that includes a first end portion located at one end of the latching frame and a second end portion located at another end of the latching frame, each having a respective guiding edge;
(b) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening;
(c) a first spring coupled at one end to the first latching member and at another end to the first end portion such that the first spring exerts a force that drives the curved part of the first latching member about the first pivot toward the guiding edge of the first end portion,
(d) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening;
(e) a second spring coupled at one end to the second latching member and at another end to the second end portion such that the second spring exerts a force that drives the curved part of the second latching member about the second pivot toward the guiding edge of the second end portion; wherein
(f) the guiding edge of the first latching member is configured to guide a first mounting pin of an external bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the first spring, and
(g) the guiding edge of the second latching member is configured to guide a second mounting pin of the external bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the second spring.

11. The latching apparatus of claim 10, further comprising
(i) a first actuating portion configured to compress the first spring and cause the first latching member to pivot away from the first end portion in response to pressure being applied to the first actuating portion, and
(ii) a second actuating portion configured to compress the second spring and cause the second latching member to pivot away from the second end portion in response to pressure being applied to the first actuating portion.

12. The latching apparatus of claim 11, wherein first and second actuating portions are configured to compress the first and second springs concurrently in response to pressure being concurrently applied to the first and second actuating portions.

13. The latching apparatus of claim 10, further comprising
(i) a first motion limiting pin formed in one of the first latching member or the first end portion, and a first opening formed in another of the first latching member or the first end portion and that receives the first motion limiting pin, wherein motion of the first latching member about the first pivot is stopped by the first motion limiting pin contacting a wall of the first opening, and
(ii) a second motion limiting pin formed in one of the second latching member or the second end portion, and a second opening formed in another of the second latching member or the second end portion and that receives the second motion limiting pin, wherein motion of the second latching member about the second pivot is stopped by the second motion limiting pin contacting a wall of the second opening.

14. A latching apparatus, comprising:
(a) a latching frame that includes a first end portion located at one end of the latching frame and a second end portion located at another end of the latching frame, each having a respective guiding edge;
(b) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening;
(c) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening;
(d) a spring coupled at one end to the first latching member and at another end to the second latching member such that the spring exerts a force that drives the curved part of the first latching member about the first pivot toward the guiding edge of the first end portion and drives the curved part of the second latching member about the second pivot toward the guiding edge of the second end portion; wherein
(e) the guiding edge of the first latching member is configured to guide a first mounting pin of an external bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the spring, and
(f) the guiding edge of the second latching member is configured to guide a second mounting pin of the external bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the spring.

15. The latching apparatus of claim 14, wherein
(i) the first latching member includes a first actuating portion, and
(ii) the second latching member includes a second actuating portion, wherein
(iii) the first actuating portion and the second actuating portion are configured to compress the spring and cause the first and second latching members to pivot away from the latching frame in response to pressure being concurrently applied to the first and second actuating portions.

16. The latching apparatus of claim 14, further comprising
(i) a first motion limiting pin formed in the first end portion of the latching frame, wherein motion of the first latching member about the first pivot is stopped by the first latching member contacting the first motion limiting pin, and
(ii) a second motion limiting pin formed in the second end portion of the latching frame, wherein motion of the second latching member about the second pivot is stopped by the second latching member contacting the second motion limiting pin.

17. A latching system, comprising:
(a) a bracket including a first mounting pin and a second mounting pin; and
(b) a latching apparatus, comprising:
(i) a latching frame that includes a first end portion located at one end of the latching frame and a second end portion located at another end of the latching frame, each having a respective guiding edge,
(ii) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening,
(iii) a first spring coupled at one end to the first latching member and at another end to the first end portion such that the first spring exerts a force that drives the curved part of the first latching member about the first pivot toward the guiding edge of the first end portion,
(iv) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening,
(v) a second spring coupled at one end to the second latching member and at another end to the second end portion such that the second spring exerts a force that drives the curved part of the second latching member about the second pivot toward the guiding edge of the second end portion, wherein
(vi) the guiding edge of the first latching member is configured to guide the first mounting pin of the bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the first spring, and
(vii) the guiding edge of the second latching member is configured to guide the second mounting pin of the bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the second spring.

18. A latching system, comprising:
(a) a bracket including a first mounting pin and a second mounting pin; and
(b) a latching apparatus, comprising:
(i) a latching frame that includes a first end portion located at one end of the latching frame and a second end portion located at another end of the latching frame, each having a respective guiding edge;
(ii) a first latching member having a curved part and a guiding edge located at an outer end of the curved part, the first latching member being coupled at a first pivot to the first end portion such that the guiding edge and the curved part of the first latching member face the guiding edge of the first end portion, the curved part of the first latching member and the guiding edge of the first end portion forming a first opening;
(iii) a second latching member having a curved part and a guiding edge located at an outer end of the curved part, the second latching member being coupled at a second pivot to the second end portion such that the guiding edge and the curved part of the second latching member face the guiding edge of the second end portion, the curved part of the second latching member and the guiding edge of the second end portion forming a second opening;
(iv) a spring coupled at one end to the first latching member and at another end to the second latching member such that the spring exerts a force that drives the curved part of the first latching member about the first pivot toward the guiding edge of the first end portion and drives the curved part of the second latching member about the second pivot toward the guiding edge of the second end portion; wherein
(v) the guiding edge of the first latching member is configured to guide the first mounting pin of the bracket toward the first opening in response to the first mounting pin being pushed against the guiding edge of the first latching member whereby the first mounting pin initially causes the first latching member to pivot away from the first end portion until the first mounting pin slides past the guiding edge of the first latching member and is secured between the curved part of the first latching member and the guiding edge of the first end portion by the force exerted by the spring, and
(vi) the guiding edge of the second latching member is configured to guide the second mounting pin of the bracket toward the second opening in response to the second mounting pin being pushed against the guiding edge of the second latching member whereby the second mounting pin initially causes the second latching member to pivot away from the second end portion until the second mounting pin slides past the guiding edge of the second latching member and is secured between the curved part of the second latching member and the guiding edge of the second end portion by the force exerted by the spring.
